(19) United States
(12) Patent Application Publication
(10) Pub. No.: US 2025/0051531 A1
(43) Pub. Date: Feb. 13, 2025

(54) FLAME-RETARDANT INSULATING SHEET AND ELECTRICAL/ELECTRONIC DEVICE

(71) Applicant: SUMITOMO BAKELITE CO., LTD., Tokyo (JP)

(72) Inventor: Katsuki Kanehara, Tokyo (JP)

(73) Assignee: SUMITOMO BAKELITE CO., LTD., Tokyo (JP)

(21) Appl. No.: 18/719,439

(22) PCT Filed: Dec. 16, 2022
(86) PCT No.: PCT/JP2022/046527

§ 371 Date: Jun. 13, 2024

(30) Foreign Application Priority Data
Dec. 16, 2021 (JP) 2021-204328

(51) Int. Cl. C08J 5/18; C08K 3/04; C08K 5/3492

(52) U.S. Cl. CPC C08J 5/18; C08K 3/04; C08K 5/34924; C08J 2369/00; C08K 2201/005

(57) ABSTRACT

The present invention provides a flame-retardant insulating sheet containing a polycarbonate resin and a flame retardant, in which the flame retardant includes a nitrogen-containing compound, and on at least one surface of the flame-retardant insulating sheet, an arithmetic mean peak curvature (Sp) is 200 (1/mm) or more, a peak density (Spd) is 8,000 (1/mm²) or more, or a 60° glossiness is 25 or less. An electrical/electronic device using the flame-retardant insulating sheet.

### TECHNICAL FIELD

The present invention relates to a flame-retardant insulating sheet and an electrical/electronic device.

Priority is claimed on Japanese Patent Application No. 2021-204328, filed on Dec. 16, 2021, the content of which is incorporated herein by reference.

### BACKGROUND ART

In the related art, a flame retardant is blended with a thermoplastic resin to impart flame retardancy to a resin molded body. For example, in order to improve the flame retardancy of the polycarbonate resin, a method of blending a large amount of an oligomer or a polymer of a brominated bisphenol A carbonate derivative has been used.

However, in order to improve the flame retardancy of the polycarbonate resin, it is necessary to blend a large amount of the oligomer or the polymer of the brominated bisphenol A carbonate derivative, and there is a problem that the impact resistance of the molded product is lowered and the breakage is likely to occur. In addition, since a large amount of halogen-based compounds containing bromine are blended, there are many problems such as generation of gas containing a halogen during combustion and generation of halogen gas harmful to the human body. Therefore, a flame-retardant resin composition containing a flame retardant in which gas containing a halogen is not generated, is desired.

As the flame retardant, in addition to the flame retardant containing bromine, ammonium polyphosphate, a phosphate ester compound, and the like are known. However, in a case where the ammonium polyphosphate is used, heat resistance and flame retardancy of the molded body are insufficient, and in a case where the phosphate ester compound is used, a large amount of the phosphate ester compound is required to be used to impart flame retardancy to the molded body, thereby there is a problem that heat resistance and mechanical characteristics of the molded body are insufficient.

As a solution to such a problem, a thermoplastic resin composition containing a cyclic phosphorus compound and a cellulose-based resin, and a film-shaped molded body formed of the thermoplastic resin composition are disclosed. It is known that a cyclic phosphorus compound not only acts as a flame retardant, but also contributes to improvement of moldability, heat resistance, bending strength, and the like of a film-shaped molded body (see PTL 1).

### CITATION LIST

### Patent Literature

[PTL 1] Japanese Unexamined Patent Application, First Publication No. 2012-05200

### SUMMARY OF INVENTION

### Technical Problem

The flame-retardant insulating sheet has various applications. For example, in an electrical/electronic device, a flame-retardant insulating sheet is sandwiched between circuit boards to prevent a short circuit between the circuit boards. In a case where the flame-retardant insulating sheet is a long length, such a flame-retardant insulating sheet is often rolled before use, and in a case where the flame-retardant insulating sheet is not a long length, the flame-retardant insulating sheet is often stacked and stored by being laminated in a thickness direction before use. In a case of the resin sheet, in a case where the resin sheets are stacked and stored in this manner, there is a problem that sticking is likely to occur and the handleability is deteriorated, and the same problem exists in the flame-retardant insulating sheet. On the other hand, the flame-retardant insulating sheet of the related art, including the film-shaped molded body disclosed in PTL 1, is not intended to solve such problems.

An object of the present invention is to provide a flame-retardant insulating sheet capable of suppressing sticking in a case of being stacked and stored, and an electrical/electronic device using the flame-retardant insulating sheet.

### Solution to Problem

The present invention employs the following configurations.
[1] A flame-retardant insulating sheet containing a polycarbonate resin and a flame retardant, in which the flame retardant includes a nitrogen-containing compound, and on at least one surface of the flame-retardant insulating sheet, an arithmetic mean peak curvature (Spc) is 200 (1/mm) or more.
[2] A flame-retardant insulating sheet containing a polycarbonate resin and a flame retardant, in which the flame retardant includes a nitrogen-containing compound, and on at least one surface of the flame-retardant insulating sheet, a peak density (Spd) is 8,000 (1/mm²) or more.
[3] A flame-retardant insulating sheet containing a polycarbonate resin and a flame retardant, in which the flame retardant includes a nitrogen-containing compound, and on at least one surface of the flame-retardant insulating sheet, a 60° glossiness is 25 or less.
[4] The flame-retardant insulating sheet according to [1] or [2], in which a 60° glossiness on the surface is 25 or less.
[5] The flame-retardant insulating sheet according to any one of [1] to [4], further containing a coloring material.
[6] The flame-retardant insulating sheet according to [5], in which the coloring material is carbon black.
[7] The flame-retardant insulating sheet according to any one of [1] to [6], in which a weight-average molecular weight of the polycarbonate resin is 15,000 to 35,000.
[8] The flame-retardant insulating sheet according to any one of [1] to [7], in which the flame retardant is melamine cyanurate.
[9] The flame-retardant insulating sheet according to any one of [1] to [8], in which an average particle diameter of the flame retardant is 1 to 30 μm.

The flame-retardant insulating sheet according to any one of [1] to [9], in which in the flame-retardant insulating sheet, a proportion of a content of the flame retardant to a content of the polycarbonate resin is 2% to 10% by mass.

An electrical/electronic device using the flame-retardant insulating sheet according to any one of [1] to [10].

### Advantageous Effects of Invention

According to the present invention, a flame-retardant insulating sheet capable of suppressing sticking in a case of being stacked and stored, and an electrical/electronic device using the flame-retardant insulating sheet, are provided.

### DESCRIPTION OF EMBODIMENTS

### Flame-Retardant Insulating Sheet

### <Flame-Retardant Insulating Sheet (1)>

A flame-retardant insulating sheet according to one embodiment of the present invention contains a polycarbonate resin and a flame retardant, in which the flame retardant includes a nitrogen-containing compound, and on at least one surface of the flame-retardant insulating sheet, an arithmetic mean peak curvature (Spc) is 200 (1/mm) or more (in the present specification, the flame-retardant insulating sheet may be referred to as “flame-retardant insulating sheet (1)”).

The “arithmetic mean peak curvature (Spc)” means an average of the principal curvatures of the peak of the surface. A small Spc indicates that the point in contact with the other object is rounded, and a large Spc indicates that the point in contact with the other object is pointed.

The flame-retardant insulating sheet (flame-retardant insulating sheet (1)) according to the present embodiment is suitable as a flame-retardant insulating sheet provided between circuit boards in electrical/electronic device because the flame-retardant insulating sheet has flame retardancy and insulation properties.

In the flame-retardant insulating sheet (1), in a case where the Spc of at least one surface is 200 (1/mm) or more, a point in contact with the other object is pointed, thereby sticking is suppressed in a case of being stacked and stored. For example, in any of a case where the long-length flame-retardant insulating sheet (1) is wound in a rolled form and stored, or a case where the non-long-length flame-retardant insulating sheet (1) is laminated in the thickness direction and stored, the sticking of the flame-retardant insulating sheet (1) is suppressed.

The flame-retardant insulating sheet (1) can be produced using a flame-retardant resin composition containing the polycarbonate resin and the flame retardant (hereinafter, may be referred to as a “flame-retardant resin composition (1)” in the present specification).

### [Polycarbonate Resin]

The flame-retardant insulating sheet (1) contains the polycarbonate resin, and thus is excellent in bending processability, punching processability, heat resistance, and insulation properties.

The polycarbonate resin contained in the flame-retardant insulating sheet (1) and the flame-retardant resin composition (1) is obtained, for example, by a phosgene method of reacting a dihydroxydiaryl compound with phosgene or an ester exchange method of reacting a dihydroxydiaryl compound with a carbonic acid ester such as diphenyl carbonate.

In the flame-retardant insulating sheet (1) and the flame-retardant resin composition (1), examples of the dihydroxydiaryl compound include bis(hydroxyaryl)alkanes such as bisphenol A, bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, 1,1-bis(4-hydroxy-3-tert-butylphenyl)propane; bis(hydroxyaryl)cycloalkanes such as 1,1-bis(4-hydroxyphenyl)cyclopentane and 1,1-bis(4-hydroxyphenyl)cyclohexane; dihydroxydiaryl ethers such as 4,4′-dihydroxydiphenyl ether and 4,4′-dihydroxy-3,3′-dimethyldiphenyl ether; dihydroxydiaryl sulfides such as 4,4′-dihydroxydiphenyl sulfide and 4,4′-dihydroxy-3,3′-dimethyldiphenyl sulfide; dihydroxydiaryl sulfoxides such as 4,4′-dihydroxydiphenyl sulfoxide and 4,4′-dihydroxy-3,3′-dimethyldiphenyl sulfoxide; dihydroxydiaryl sulfones such as 4,4′-dihydroxydiphenyl sulfone and 4,4′-dihydroxy-3,3′-dimethyldiphenyl sulfone; and the like.

In the flame-retardant insulating sheet (1) and the flame-retardant resin composition (1), the dihydroxydiaryl compound may be used alone or in combination of two or more types thereof, and in a case of using two or more types thereof in combination, a combination and a ratio of the two or more types thereof can be optionally selected.

In the flame-retardant insulating sheet (1) and the flame-retardant resin composition (1), a weight-average molecular weight (Mw) of the polycarbonate resin is not particularly limited. The weight-average molecular weight is, for example, preferably 15,000 to 35,000, more preferably 20,000 to 35,000, and still more preferably 20,000 to 30,000. In a case where the weight-average molecular weight is in such a range, variation in thickness of the flame-retardant insulating sheet (1) is further reduced.

In the present specification, the “weight-average molecular weight” is a polystyrene-equivalent value measured by a gel permeation chromatography (GPC) method, unless otherwise specified, not only in a case of a polycarbonate resin.

In a case of producing the polycarbonate resin in the flame-retardant insulating sheet (1) and the flame-retardant resin composition (1), a molecular weight regulator, a catalyst, or the like may be used as necessary.

### [Flame Retardant]

The flame retardant contained in the flame-retardant insulating sheet (1) and the flame-retardant resin composition (1) includes a nitrogen-containing compound. The flame-retardant insulating sheet (1) contains a flame retardant including a nitrogen-containing compound, and thus has sufficient flame retardancy. In the present specification, the nitrogen-containing compound means a compound having a nitrogen atom as a constituent atom.

From the viewpoint of further improving the flame retardancy of the flame-retardant insulating sheet (1), the flame retardant (nitrogen-containing compound) is preferably a compound having a triazine skeleton.

Examples of the compound (flame retardant) having a triazine skeleton, contained in the flame-retardant insulating sheet (1) and the flame-retardant resin composition (1), include melamine; melamine derivatives such as butylmelamine, trimethylolmelamine, hexamethylolmelamine, hexamethoxymethylmelamine, and melamine phosphate; cyanuric acid; cyanuric acid derivatives such as methyl cyanurate, diethyl cyanurate, trimethyl cyanurate, and triethyl cyanurate; isocyanuric acid; isocyanuric acid derivatives such as methylisocyanurate, N,N′-diethylisocyanurate, trismethyl isocyanurate, trisethyl isocyanurate, bis(2-carboxyethyl) isocyanurate, 1,3,5-tris(2-carboxyethyl)isocyanurate, and tris(2,3-epoxypropyl)isocyanurate; melamine cyanurate; melamine cyanurate derivatives; melamine isocyanurate; melamine isocyanurate derivatives; and the like.

In the present specification, in a case where, in a certain specific compound, a structure in which one or more hydrogen atoms are substituted with a group other than a hydrogen atom is assumed, the compound having such a substituted structure is referred to as a “derivative” of the specific compound.

In the present specification, the “group” includes not only an atomic group having a structure in which a plurality of atoms are bonded but also one atom, unless otherwise specified.

The flame-retardant insulating sheet (1) and the flame-retardant resin composition (1) may contain only one type of the flame retardant (nitrogen-containing compound), or may contain two or more types thereof, and in a case of containing two or more types thereof, a combination and a ratio of the two or more types thereof can be optionally selected.

From the viewpoint that the flame retardancy of the flame-retardant insulating sheet (1) is further improved, the flame-retardant insulating sheet (1) and the flame-retardant resin composition (1) more preferably contain one type or two or more types of flame retardants (nitrogen-containing compounds) selected from the group consisting of melamine, a melamine derivative, a melamine cyanurate, a melamine cyanurate derivative, a melamine isocyanurate, and a melamine isocyanurate derivative, and melamine cyanurate is still more preferable.

An average particle diameter of the flame retardant (nitrogen-containing compound) contained in the flame-retardant insulating sheet (1) and the flame-retardant resin composition (1) is preferably 0.3 to 32 μm, more preferably 0.7 to 30 μm, and still more preferably 1 to 30 μm, and may be, for example, 0.7 to 7 μm, 1 to 10 μm, or 10 to 30 μm. In a case where the average particle diameter of the flame retardant is in such a range, the flame-retardant insulating sheet (1) has higher flame retardancy. In addition, in the resin or the resin composition (for example, the flame-retardant resin composition (1)), the flame retardant is more favorably dispersed, and for example, the average particle diameter of the flame retardant can be more easily measured by a laser diffraction/scattering-type particle diameter distribution measuring method described later. Provided that this is an example of the average particle diameter.

In the present specification, as well as a case of a flame retardant, the “average particle diameter” means a particle diameter at a time when 50% of the particles are accumulated, which is measured by a laser diffraction/scattering-type particle diameter distribution measuring method, and is also referred to as “D50”.

In the flame-retardant insulating sheet (1) and the flame-retardant resin composition (1), a proportion of the content of the flame retardant (nitrogen-containing compound) to the content of the polycarbonate resin is preferably 2% to 10% by mass, and is, for example, any of 2% to 8% by mass or 2% to 6% by mass, any of 6% to 10% by mass or 8% to 10% by mass, or 4% to 8% by mass. In a case where the proportion is equal to or more than the lower limit value, the flame retardancy of the flame-retardant insulating sheet (1) is further improved. In a case where the proportion is equal to or less than the upper limit value, excessive use of the flame retardant is suppressed. Provided that this is an example of the proportion.

### [Coloring Material]

The flame-retardant insulating sheet (1) may further contain a coloring material in addition to the polycarbonate resin and the flame retardant. Since the flame-retardant insulating sheet (1) contains the coloring material to be colored, and has opacifying property, the flame-retardant insulating sheet is suitable as a flame-retardant insulating sheet provided between circuit boards in electrical/electronic device.

In a case where the flame-retardant insulating sheet (1) further contains a coloring material in addition to the polycarbonate resin and the flame retardant, the flame-retardant insulating sheet (1) can be produced using the flame-retardant resin composition (1) containing the polycarbonate resin, the flame retardant, and the coloring material.

The coloring material contained in the flame-retardant insulating sheet (1) and the flame-retardant resin composition (1) may be, for example, a known coloring material which is used in combination with a thermoplastic resin.

Examples of the coloring material include a coloring material for imparting the opacifying property to the flame-retardant insulating sheet (1) containing the coloring material.

The term “opacifying property” means a degree to which the substrate is not visible. The coloring material having high opacifying property has high performance for opacifying the color of the substrate.

More specific examples of the coloring material contained in the flame-retardant insulating sheet (1) and the flame-retardant resin composition (1) include an organic pigment, an inorganic pigment, a dye, and the like.

From the viewpoint of imparting high opacifying property to the flame-retardant insulating sheet (1), the coloring material contained in the flame-retardant insulating sheet (1) and the flame-retardant resin composition (1) is preferably a black coloring material.

Examples of the black coloring material include carbon black, titanium black, iron oxide, graphite, and the like.

The flame-retardant insulating sheet (1) and the flame-retardant resin composition (1) may contain only one type of coloring material, or may contain two or more types thereof, and in a case of containing two or more types thereof, a combination and a ratio of the two or more types thereof can be optionally selected.

From the viewpoint that the flame-retardant insulating sheet (1) has higher flame retardancy and higher opacifying property, the coloring material contained in the flame-retardant insulating sheet (1) and the flame-retardant resin composition (1) is preferably carbon black.

In a case where the flame-retardant insulating sheet (1) and the flame-retardant resin composition (1) further contain a coloring material in addition to the polycarbonate resin and the flame retardant, a proportion of the content of the coloring material to the content of the polycarbonate resin is preferably 0.01% to 0.25% by mass, and for example, may be 0.01% by mass or more and less than 0.15% by mass, or may be 0.15% to 0.25% by mass. In a case where the proportion is equal to or more than the lower limit value, the flame-retardant insulating sheet (1) has higher flame retardancy and higher opacifying property. In a case where the proportion is equal to or less than the upper limit value, the excessive use of the coloring material is suppressed. Provided that this is an example of the proportion.

### [Other Components]

The flame-retardant insulating sheet (1) and the flame-retardant resin composition (1) may contain a silicate compound.

In the flame-retardant insulating sheet (1) and the flame-retardant resin composition (1), a proportion of the content of the silicate compound to the content of the polycarbonate resin is preferably less than 2% by mass, more preferably less than 1% by mass, still more preferably less than 0.5% by mass, even still more preferably less than 0.1% by mass, and particularly preferably 0% by mass.

The flame-retardant insulating sheet (1) and the flame-retardant resin composition (1) may contain, as necessary, other components in addition to the polycarbonate resin, the flame retardant, and the coloring material, within a range in which the effects of the present invention is not impaired.

The other components can be optionally selected depending on the purpose, and are not particularly limited.

Examples of the other components include other resins not corresponding to the polycarbonate resin, various additives known in the field not corresponding to the silicate compound, and the like.

The flame-retardant insulating sheet (1) and the flame-retardant resin composition (1) may contain only one type of the other component, or may contain two or more types thereof, and in a case of containing two or more types thereof, a combination and a ratio of the two or more types thereof can be optionally selected.

### (Other Resins)

Examples of the other resins contained in the flame-retardant insulating sheet (1) and the flame-retardant resin composition (1) include polyolefin, polyester, polyethylene terephthalate, polyarylate, polybutylene terephthalate, polylactic acid, a styrene-based copolymer (a copolymer having a constitutional unit derived from styrene), polyacetal, polyamide, polyphenylene ether, polyphenylene sulfide, polymethyl methacrylate, a cellulose ester resin, and the like.

Examples of the polyolefin include high-density polyethylene, polypropylene, polybutene, an ethylene-(meth) acrylic acid copolymer, an ethylene-(meth) acrylic acid methyl copolymer, an ethylene-(meth) acrylic acid ethyl copolymer, an ethylene-vinyl acetate copolymer, a maleic acid anhydride-modified polyethylene, a carboxylic acid-modified polyethylene, an ethylene-propylene copolymer, an ethylene-propylene-diene copolymer, and the like.

In the present specification, the “(meth) acrylic acid” is a concept including both an “acrylic acid” and a “methacrylic acid”.

The flame-retardant insulating sheet (1) and the flame-retardant resin composition (1) may contain only one type of the other resin, or may contain two or more types thereof, and in a case of containing two or more types thereof, a combination and a ratio of the two or more types thereof can be optionally selected.

### (Additive)

Examples of the additive contained in the flame-retardant insulating sheet (1) and the flame-retardant resin composition (1) include a stabilizer, a lubricant, a processing aid, an antistatic agent, an antioxidant, a neutralizing agent, an ultraviolet absorber, a dispersant, a thickener, and the like.

The flame-retardant insulating sheet (1) and the flame-retardant resin composition (1) may contain only one type of the additive, or may contain two or more types thereof, and in a case of containing two or more types thereof, a combination and a ratio of the two or more types thereof can be optionally selected.

In the flame-retardant insulating sheet (1), a proportion of the total content of the polycarbonate resin and the flame retardant to the total mass of the flame-retardant insulating sheet (1) (([content of polycarbonate resin in flame-retardant insulating sheet (1) (part by mass)]+[content of flame retardant in flame-retardant insulating sheet (1) (part by mass)])/[total mass of flame-retardant insulating sheet (1) (part by mass)]×100) is preferably 80% by mass or more and more preferably 90% by mass or more, and for example, may be any of 95% by mass or more, 97% by mass or more, or 99% by mass or more. In a case where the proportion is equal to or more than the lower limit value, the flame retardancy, the insulation properties, the opacifying property, the bending processability, the punching processability, and the heat resistance of the flame-retardant insulating sheet (1) are further improved.

The proportion is usually the same as a proportion of the total content of the polycarbonate resin and the flame retardant to the total content (part by mass) of the components which do not vaporize at normal temperature in the flame-retardant resin composition (1) (([content (part by mass) of polycarbonate resin in flame-retardant resin composition (1)]+[content (part by mass) of flame retardant in flame-retardant resin composition (1)])/[total content (part by mass) of components which do not vaporize at normal temperature in flame-retardant resin composition (1)]×100).

In other words, for the same reason as described above, the proportion of the content of the other components in the flame-retardant insulating sheet (1) to the total mass of the flame-retardant insulating sheet (1) ([content of other components in flame-retardant insulating sheet (1) (part by mass)]/[total mass of flame-retardant insulating sheet (1)]×100) is preferably 20% by mass or less and more preferably 10% by mass or less, and for example, may be any of 5% by mass or less, 3% by mass or less, or 1% by mass or less.

The proportion is usually the same as a proportion of the content of the other components to the total content (part by mass) of the components not vaporized at normal temperature in the flame-retardant resin composition (1) ([content of other components in the flame-retardant resin composition (1) (part by mass)]/[total content of components not vaporized at normal temperature in the flame-retardant resin composition (1) (part by mass)]×100).

### [Characteristics of Flame-Retardant Insulating Sheet (1)]

The Spc of one surface or both surfaces of the flame-retardant insulating sheet (1) is 200 (1/mm) or more, and may be, for example, any of 400 (1/mm) or more, 600 (1/mm) or more, or 700 (1/mm) or more. In a case where the Spc is equal to or more than the lower limit value, the point in contact with the other object is pointed, thereby sticking of the flame-retardant insulating sheet (1) in a case of being stacked and stored is suppressed.

In the present specification, the Spc of the surface of the sheet is a value measured in accordance with ISO 25178, not only in a case of the flame-retardant insulating sheet (1).

An upper limit value of Spc of one surface or both surfaces of the flame-retardant insulating sheet (1) is not particularly limited. From the viewpoint that the Spc is not excessively increased and the flame-retardant insulating sheet (1) can be more easily produced, the Spc is preferably 2,100 (1/mm) or less.

The Spc of one surface or both surfaces of the flame-retardant insulating sheet (1) may be, for example, any of 200 to 2,100 (1/mm), 400 to 2,100 (1/mm), 600 to 2,100 (1/mm), or 700 to 2,100 (1/mm).

The Spc of both surfaces of the flame-retardant insulating sheet (1) may be the same as or different from each other, regardless of whether or not the Spc is 200 (1/mm) or more.

The 60° glossiness on at least one surface of the flame-retardant insulating sheet (1) (surface on which the Spc is 200 (1/mm) or more) is preferably 25 or less, and for example, may be any of 20 or less, 15 or less, or 10 or less. In a case where the 60° glossiness on one surface or both surfaces of the flame-retardant insulating sheet (1) is equal to or less than the upper limit value, the smoothness of the surface is further suppressed, and sticking of the flame-retardant insulating sheet (1) in a case of being stacked and stored is further suppressed. In addition, even in a case where the surface of the flame-retardant insulating sheet (1) has scratches, the presence of the scratches is not noticeable.

In the present specification, the 60° glossiness on the surface of the sheet is a value measured in accordance with JIS Z 8741, not only in a case of the flame-retardant insulating sheet (1).

The lower limit value of the 60° glossiness on one surface or both surfaces (surface on which Spc is 200 (1/mm) or more) of the flame-retardant insulating sheet (1) is not particularly limited. From the viewpoint that the 60° glossiness is not excessively decreased and the flame-retardant insulating sheet (1) can be more easily produced, the 60° glossiness is preferably 5 or more.

The 60° glossiness on one surface or both surfaces (surface on which Spc is 200 (1/mm) or more) of the flame-retardant insulating sheet (1) may be, for example, any of 5 to 25, 5 to 20, 5 to 15, or 5 to 10.

The 60° glossiness on both surfaces of the flame-retardant insulating sheet (1) may be the same as or different from each other.

A thickness of the flame-retardant insulating sheet (1) is not particularly limited, and can be optionally selected according to the purpose.

For example, the thickness of the flame-retardant insulating sheet (1) is preferably 30 to 900 μm, and may be any of 300 to 600 μm, 600 to 900 μm, or 400 to 500 μm.

The flame-retardant insulating sheet (1) has flame retardancy and can satisfy a UL94 vertical burning test V-0 standard.

### [Method for Producing Flame-Retardant Insulating Sheet (1)]

The flame-retardant insulating sheet (1) can be produced, for example, using the flame-retardant resin composition (1), by applying a known molding method such as a calendering method, an extrusion method, a pressing method, or a casting method to form a resin sheet.

In this case, the resin sheet obtained above may be used as it is as the flame-retardant insulating sheet (1). Alternatively, on one surface or both surfaces of the resin sheet obtained above, for example, a surface state is adjusted, a heated press plate is brought into contact therewith, and the resin sheet is heated and pressured with the press plate, and the surface state of the press plate is transferred to one surface or both surfaces of the resin sheet, thereby a flame-retardant insulating sheet (1) in which the Spc of one surface or both surfaces satisfies the above-described conditions (Spc is adjusted) can be produced.

The 60° glossiness on the flame-retardant insulating sheet (1) on one surface or both surfaces can also be adjusted by the same method as in the case of adjusting the Spc described above, by transferring the surface state of the press plate to these surfaces.

### <Flame-Retardant Insulating Sheet (2)>

A flame-retardant insulating sheet according to one embodiment of the present invention contains a polycarbonate resin and a flame retardant, in which the flame retardant includes a nitrogen-containing compound, and on at least one surface of the flame-retardant insulating sheet, a peak density (Spd) is 8,000 (1/mm²) or more (in the present specification, the flame-retardant insulating sheet may be referred to as “flame-retardant insulating sheet (2)”).

The “peak density (Spd)” means the number of peak points per unit area. A large Spd indicates that the number of contact points with other objects is large.

The flame-retardant insulating sheet (flame-retardant insulating sheet (2)) according to the present embodiment is suitable as a flame-retardant insulating sheet provided between circuit boards in electrical/electronic device because the flame-retardant insulating sheet has flame retardancy and insulation properties.

In the flame-retardant insulating sheet (2), in a case where the Spd of at least one surface is 8,000 (1/mm²) or more, the number of contact points with other objects is increased and the contact area is decreased, thereby sticking is suppressed in a case of being stacked and stored. For example, in any of a case where the long-length flame-retardant insulating sheet (2) is wound in a rolled form and stored, or a case where the non-long-length flame-retardant insulating sheet (2) is laminated in the thickness direction and stored, the sticking of the flame-retardant insulating sheet (2) is suppressed.

The flame-retardant insulating sheet (2) may further contain a coloring material in addition to the polycarbonate resin and the flame retardant. Since the flame-retardant insulating sheet (2) contains the coloring material to be colored, and has opacifying property, the flame-retardant insulating sheet is suitable as a flame-retardant insulating sheet provided between circuit boards in electrical/electronic device.

The flame-retardant insulating sheet (2) can be produced using a flame-retardant resin composition containing the polycarbonate resin and the flame retardant (hereinafter, may be referred to as a “flame-retardant resin composition (2)” in the present specification).

In a case where the flame-retardant insulating sheet (2) further contains a coloring material in addition to the polycarbonate resin and the flame retardant. the flame-retardant insulating sheet (2) can be produced using the flame-retardant resin composition (2) containing the polycarbonate resin, the flame retardant, and the coloring material.

The flame-retardant resin composition (2) may contain, as necessary, other components in addition to the polycarbonate resin, the flame retardant, and the coloring material, within a range in which the effects of the present invention are not impaired.

The polycarbonate resin, the flame retardant, the coloring material, and the other components, which are contained in the flame-retardant insulating sheet (2) and the flame-retardant resin composition (2), are each the same as the polycarbonate resin, the flame retardant, the coloring material, and the other components, which are contained in the flame-retardant insulating sheet (1) and the flame-retardant resin composition (1).

The flame-retardant resin composition (2) may be the same as the flame-retardant resin composition (1), and a detailed description thereof will be omitted.

The peak density (Spd) on at least one surface of the flame-retardant insulating sheet (2) is 8,000 (1/mm²) or more, and may be, for example, any of 10,000 (1/mm²) or more, 12.000 (1/mm²) or more, or 15,000 (1/mum²) or more. In a case where the Spd of one surface or both surfaces of the flame-retardant insulating sheet (2) is equal to or more than the lower limit value, the number of contact points with other objects is increased and the contact area is decreased, thereby sticking of the flame-retardant insulating sheet (2) in a case of being stacked and stored is suppressed.

In the present specification, the Spd of the surface of the sheet is a value measured in accordance with ISO 25178, not only in a case of the flame-retardant insulating sheet (2).

The upper limit value of the Spd of one surface or both surfaces of the flame- retardant insulating sheet (2) is not particularly limited. From the viewpoint that the Spd is not excessively increased and the flame-retardant insulating sheet (2) can be more easily produced, the Spd is preferably 22,000 (1/mm²) or less.

The Spd of one surface or both surfaces of the flame-retardant insulating sheet (2) may be, for example, any of 8,000 to 22,000 (1/mm²), 10,000 to 22,000 (1/mm²), 12,000 to 22,000 (1/mm²), or 15,000 to 22,000 (1/mm²).

The Spd of both surfaces of the flame-retardant insulating sheet (2) may be the same as or different from each other, regardless of whether or not the Spd is 8,000 (1/mm²) or more.

The flame-retardant insulating sheet (2) may be the same as the flame-retardant insulating sheet (1) described above, except that at least one surface of flame-retardant insulating sheet (2) satisfies the above-described condition of the Spd instead of the Spc condition described above.

For example, the flame-retardant insulating sheet (2) has flame retardancy and can satisfy a UL94 vertical burning test V-0 standard.

The 60° glossiness on at least one surface of the flame-retardant insulating sheet (2) (surface on which the Spd is 8,000 (1/mm²) or more) is preferably 25 or less, and for example, may be any of 20 or less, 15 or less, or 10 or less. In a case where the 60° glossiness on one surface or both surfaces of the flame-retardant insulating sheet (2) is equal to or less than the upper limit value, the smoothness of the surface is further suppressed, and sticking of the flame-retardant insulating sheet (2) in a case of being stacked and stored is further suppressed.

The lower limit value of the 60° glossiness on one surface or both surfaces (surface on which Spd is 8,000 (1/mm²) or more) of the flame-retardant insulating sheet (2) is not particularly limited. From the viewpoint that the 60° glossiness is not excessively decreased and the flame-retardant insulating sheet (2) can be more easily produced, the 60° glossiness is preferably 5 or more. The 60° glossiness on one surface or both surfaces (surface on which Spd is 8,000 (1/mm²) or more) of the flame-retardant insulating sheet (2) may be, for example, any of 5 to 25, 5 to 20, 5 to 15, or 5 to 10.

The 60° glossiness on both surfaces of the flame-retardant insulating sheet (2) may be the same as or different from each other.

A thickness of the flame-retardant insulating sheet (2) is not particularly limited, and can be optionally selected according to the purpose.

For example, the thickness of the flame-retardant insulating sheet (2) is preferably 30 to 900 μm, and may be any of 300 to 600 μm, 600 to 900 μm, or 400 to 500 μm.

### [Method for Producing Flame-Retardant Insulating Sheet (2)]

The flame-retardant insulating sheet (2) can be produced, for example, using the flame-retardant resin composition (2), by applying a known molding method such as a calendering method, an extrusion method, a pressing method, or a casting method to form a resin sheet.

In this case, the resin sheet obtained above may be used as it is as the flame-retardant insulating sheet (2). Alternatively, on one surface or both surfaces of the resin sheet obtained above, for example, a surface state is adjusted, a heated press plate is brought into contact therewith, and the resin sheet is heated and pressured with the press plate, and the surface state of the press plate is transferred to one surface or both surfaces of the resin sheet, thereby a flame-retardant insulating sheet (2) in which the Spd of one surface or both surfaces satisfies the above-described conditions can be produced.

The 60° glossiness on the flame-retardant insulating sheet (2) on one surface or both surfaces can also be adjusted by the same method as in the case of adjusting the Spd described above, by transferring the surface state of the press plate to these surfaces.

### <Flame-Retardant Insulating Sheet (3)>

A flame-retardant insulating sheet according to one embodiment of the present invention contains a polycarbonate resin and a flame retardant, in which the flame retardant includes a nitrogen-containing compound, and on at least one surface of the flame-retardant insulating sheet, a 60° glossiness is 25 or less (in the present specification, the flame-retardant insulating sheet may be referred to as “flame-retardant insulating sheet (3)”).

The term “60° glossiness” means an intensity ratio between incident light and regular reflection light (reflection light having an equal incident angle and reflection angle) in a case where the object is irradiated with light at an incident angle of 60°. In a case where the surface is smooth, specular reflection is dominant and thus the glossiness is increased, and in a case where the surface is rough, the surface is diffusely reflected in various directions and thus the glossiness is decreased.

The flame-retardant insulating sheet (flame-retardant insulating sheet (3)) according to the present embodiment is suitable as a flame-retardant insulating sheet provided between circuit boards in electrical/electronic device because the flame-retardant insulating sheet has flame retardancy and insulation properties.

In the flame-retardant insulating sheet (3), in a case where the 60° glossiness on at least one surface is 25 or less, the surface smoothness is suppressed and the sticking in a case of being stacked and stored is suppressed. For example, in any of a case where the long-length flame-retardant insulating sheet (3) is wound in a rolled form and stored, or a case where the non-long-length flame-retardant insulating sheet (3) is laminated in the thickness direction and stored, the sticking of the flame-retardant insulating sheet (3) is suppressed.

The flame-retardant insulating sheet (3) may further contain a coloring material in addition to the polycarbonate resin and the flame retardant. Since the flame-retardant insulating sheet (3) contains the coloring material to be colored, and has opacifying property, the flame-retardant insulating sheet is suitable as a flame-retardant insulating sheet provided between circuit boards in electrical/electronic device.

The flame-retardant insulating sheet (3) can be produced using a flame-retardant resin composition containing the polycarbonate resin and the flame retardant (hereinafter, may be referred to as a “flame-retardant resin composition (3)” in the present specification).

In a case where the flame-retardant insulating sheet (3) further contains a coloring material in addition to the polycarbonate resin and the flame retardant, the flame-retardant insulating sheet (3) can be produced using the flame-retardant resin composition (3) containing the polycarbonate resin, the flame retardant, and the coloring material.

The flame-retardant resin composition (3) may contain, as necessary, other components in addition to the polycarbonate resin, the flame retardant, and the coloring material, within a range in which the effects of the present invention are not impaired.

The polycarbonate resin, the flame retardant, the coloring material, and the other components, which are contained in the flame-retardant insulating sheet (3) and the flame-retardant resin composition (3), are each the same as the polycarbonate resin, the flame retardant, the coloring material, and the other components, which are contained in the flame-retardant insulating sheet (1) and the flame-retardant resin composition (1).

The flame-retardant resin composition (3) may be the same as the flame-retardant resin composition (1), and a detailed description thereof will be omitted.

The 60° glossiness on at least one surface of the flame-retardant insulating sheet (3) is 25 or less, and may be, for example, any of 20 or less, 15 or less, or 10 or less. In a case where the 60° glossiness on one surface or both surfaces of the flame-retardant insulating sheet (3) is equal to or less than the upper limit value, the smoothness of the surface is further suppressed, and sticking of the flame-retardant insulating sheet (3) in a case of being stacked and stored is further suppressed.

The lower limit value of the 60° glossiness on one surface or both surfaces of the flame-retardant insulating sheet (3) is not particularly limited. From the viewpoint that the 60° glossiness is not excessively decreased and the flame-retardant insulating sheet (3) can be more easily produced, the 60° glossiness is preferably 5 or more.

The 60° glossiness on one surface or both surfaces of the flame-retardant insulating sheet (3) may be, for example, any of 5 to 25, 5 to 20, 5 to 15, or 5 to 10.

The 60° glossiness on both surfaces of the flame-retardant insulating sheet (3) may be the same as or different from each other, regardless of whether or not each 60° glossiness on both surfaces of the flame-retardant insulating sheet (3) is 25 or less.

The flame-retardant insulating sheet (3) may be the same as the flame-retardant insulating sheet (1) described above, except that at least one surface of the flame-retardant insulating sheet (3) satisfies the above-described condition of the 60° glossiness instead of the Spc condition described above.

For example, the flame-retardant insulating sheet (3) has flame retardancy and can satisfy a UL94 vertical burning test V-0 standard.

A thickness of the flame-retardant insulating sheet (3) is not particularly limited, and can be optionally selected according to the purpose.

For example, the thickness of the flame-retardant insulating sheet (3) is preferably 30 to 900 μm, and may be any of 300 to 600 μm, 600 to 900 μm, or 400 to 500 μm.

### [Method for Producing Flame-Retardant Insulating Sheet (3)]

The flame-retardant insulating sheet (3) can be produced, for example, using the flame-retardant resin composition (3), by applying a known molding method such as a calendering method, an extrusion method, a pressing method, or a casting method to form a resin sheet.

In this case, the resin sheet obtained above may be used as it is as the flame-retardant insulating sheet (3). Alternatively, on one surface or both surfaces of the resin sheet obtained above, for example, a surface state is adjusted, a heated press plate is brought into contact therewith, and the resin sheet is heated and pressured with the press plate, and the surface state of the press plate is transferred to one surface or both surfaces of the resin sheet, thereby a flame-retardant insulating sheet (3) in which the 60° glossiness on one surface or both surfaces satisfies the above-described conditions can be produced.

### <Preferred Flame-Retardant Insulating Sheet>

Preferred examples of the flame-retardant insulating sheet according to the present embodiment include a flame-retardant insulating sheet (1) in which the 60° glossiness on a surface of the flame-retardant insulating sheet (1) in which the Spc is 200 (1/mm) or more is 25 or less, and a flame-retardant insulating sheet (2) in which the 60° glossiness on a surface of the flame-retardant insulating sheet (2) in which the Spd is 8,000 (1/mm²) or more is 25 or less.

On one surface or both surfaces of the flame-retardant insulating sheet (1), a high negative correlation is present between the Spc and the 60° glossiness. Similarly, on one surface or both surfaces of the flame-retardant insulating sheet (2), a high negative correlation is present between the Spd and the 60° glossiness.

However, generally in the resin sheet, it cannot be said that there is always a high correlation between the Spc and the 60° glossiness on one surface or both surfaces. In the one surface or both surfaces of the flame-retardant insulating sheet (1) and the flame-retardant insulating sheet (2), there is no high correlation between the parameter related to the surface roughness, not corresponding to any of Spc or Spd, and the 60° glossiness.

That is, both the flame-retardant insulating sheet (1) satisfying the relationship between the Spc and the 60° glossiness and the flame-retardant insulating sheet (2) satisfying the relationship between the Spd and the 60° glossiness have an extremely limited configuration.

### Electrical/Electronic Device

The electrical/electronic device according to the embodiment of the present invention is configured by using the flame-retardant insulating sheet according to the embodiment of the present invention described above, that is, one type or two or more types selected from the group consisting of the flame-retardant insulating sheet (1), the flame-retardant insulating sheet (2), and the flame-retardant insulating sheet (3).

Examples of the electrical/electronic device according to the present embodiment include an electrical/electronic device configured such that the flame-retardant insulating sheet is sandwiched between circuit boards. In such an electrical/electronic device, the flame-retardant insulating sheet prevents a short circuit between the circuit boards.

### EXAMPLES

Hereinafter, the present invention will be described in more detail by way of specific Examples. Provided that the present invention is not intended to be limited to the following Examples.

The raw materials used in each of Examples and Comparative Examples are shown below.

### [Polycarbonate Resin]

PC(1): “E-2000” manufactured by Mitsubishi Engineering-Plastics Corporation; weight-average molecular weight of 27,000

PC(2): “H-3000” manufactured by Mitsubishi Engineering-Plastics Corporation; weight-average molecular weight of 20,000

### Flame Retardant

MC(1): melamine cyanurate (“MC-6000” manufactured by Nissan Chemical Corporation, average particle diameter (D50) of 1 to 4 μm)

MC(2): melamine cyanurate (“MC-4000” manufactured by Nissan Chemical Corporation, average particle diameter (D50) of 10 to 30 μm)

### Coloring Material

CB (1): carbon black CB40

### Example 1

### Production of Flame-Retardant Insulating Sheet

The PC (1) (100 parts by mass) and the MC (1) (6 parts by mass) were melt-kneaded using a biaxial extruder to produce pellets corresponding to the flame-retardant resin composition.

The obtained pellets were extruded in a sheet shape using a same direction biaxial extruder and a T-die or the like, and the thickness thereof was adjusted.

A pair of press plates were prepared. For one surface of the press plate, the Spc measured in accordance with ISO 25178 was 1,400 (1/mm), and for the other surface of the press plate, the Spc measured in accordance with ISO 25178 was 1,900 (1/mm).

The sheet obtained above was sandwiched between a pair of press plates having the above-described Spc, and using a hot press machine, the press plates were heated to about 180° C., pressurized while melting PC (1), and rapidly cooled to obtain a target flame-retardant insulating sheet (thickness of 400 μm).

### Evaluation of Flame-Retardant Insulating Sheet

<Measurement of Spc, Spd, and 60° glossiness>

On one surface of the flame-retardant insulating sheet obtained above, Spc and Spd were measured using a laser microscope (“VK-X3000” manufactured by KEYENCE CORPORATION) in accordance with ISO 25178, and a 60° glossiness was measured using “PG1” manufactured by Nippon Denshoku Industries Co., Ltd. in accordance with JIS Z 8741. The results are shown in Table 1.

### <Evaluation of Sticking Suppressing Effect>

The two obtained flame-retardant insulating sheets were overlapped with each other on the surfaces thereof to laminate the flame-retardant insulating sheets, and a weight was placed on the upper surface of the obtained laminate to store the laminate at normal temperature for 24 hours while applying a pressure of 500 g/cm² to the laminate in the thickness direction.

Next, the weight was removed from the laminate at room temperature, and the presence or absence of sticking of the two flame-retardant insulating sheets in the laminate was checked. In a case where the sticking was not observed, it was determined that “A: sticking suppressing effect was present”, and in a case where the sticking was observed, it was determined that “B: sticking suppressing effect was absent”. The results are shown in Table 1.

### Production and Evaluation of Flame-Retardant Insulating Sheet

### Examples 2 to 9

A flame-retardant insulating sheet was produced and evaluated in the same manner as in Example 1, except that CB (1) (0.1 parts by mass) was added as a content component of the flame-retardant insulating sheet, and at least one of the type or the blending amount of the blending component was changed such that the type and content of the content components of the flame-retardant insulating sheet were as shown in Table 1 or 2. The results are shown in Table 1.

### Comparative Example 1

A pair of press plates were prepared. For one surface of the press plate, the Spc measured in accordance with ISO 25178 was 150 (1/mm), and for the other surface of the press plate, the Spc measured in accordance with ISO 25178 was 180 (1/mm).

A flame-retardant insulating sheet was produced and evaluated in the same manner as in Example 1, except that the pair of press plates was used. The results are shown in Table 1.

TABLE 1

| | | | Example | | | | |
|---|---|---|---|---|---|---|---|
| | | | 1 | 2 | 3 | 4 | 5 |
| Content | Polycarbonate | PC(1) | 100 | 100 | 100 | 100 | — |
| component | resin | PC(2) | — | — | — | — | 100 |
| (part by | Flame retardant | MC(1) | 6 | 6 | 6 | — | 6 |
| mass) | | MC(2) | — | — | — | 6 | — |
| | Coloring material | CB(1) | — | 0.1 | 0.1 | 0.1 | 0.1 |

| | | | | | | |
|---|---|---|---|---|---|---|
| Evaluation | Spc | 700 | 700 | 220 | 280 | 520 |
| result | Spd | 9,000 | 9,000 | 12,000 | 12,500 | 10,500 |
| | 60° glossiness | 5 | 5 | 22 | 25 | 6 |
| | Sticking suppressing effect | A | A | A | A | A |

TABLE 2

| | | | Example | | | | Comparative |
|---|---|---|---|---|---|---|---|
| | | | 6 | 7 | 8 | 9 | Example 1 |
| Content | Polycarbonate | PC(1) | 100 | 100 | 100 | 100 | 100 |
| component | resin | PC(2) | — | — | — | — | — |
| (part by | Flame retardant | MC(1) | 6 | 2 | 8 | 10 | 6 |
| mass) | | MC(2) | — | — | — | — | — |
| | Coloring material | CB(1) | 0.1 | 0.1 | 0.1 | 0.1 | 0.1 |

| | | | | | | |
|---|---|---|---|---|---|---|
| Evaluation | Spc | 800 | 500 | 250 | 1,300 | 76 |
| result | Spd | 20,000 | 11,000 | 12,000 | 20,000 | — |
| | 60° glossiness | 12 | 12 | 20 | 10 | 34 |
| | Sticking suppressing effect | A | A | A | A | B |

As is evident from the above-described results, in Examples 1 to 9, the sticking of the flame-retardant insulating sheet was suppressed. In Examples 1 to 9, Spc was 220 (1/mm) or more (220 to 1,300 (1/mm)), Spd was 9,000 (1/mm²) or more (9,000 to 20,000 (1/mm²)), and the 60° glossiness was 25 or less (5 to 25).

On the other hand, in Comparative Example 1, the sticking of the flame-retardant insulating sheet was not suppressed. In Comparative Example 1, Spc was 76 (1/mm), Spd was less than the detection limit value, and the 60° glossiness was 34.

### INDUSTRIAL APPLICABILITY

The present invention is available as a flame-retardant insulating sheet provided between circuit boards in electrical/electronic device (for example, device for a high voltage, such as an industrial power supply and a vehicle-mounted device).

1. A flame-retardant insulating sheet, comprising:
a polycarbonate resin; and
a flame retardant,
wherein the flame retardant comprises a nitrogen-containing compound, and
on at least one surface of the flame-retardant insulating sheet, an arithmetic mean peak curvature (Spc) is 200 (1/mm) or more.

2. A flame-retardant insulating sheet, comprising:
a polycarbonate resin; and
a flame retardant,
wherein the flame retardant comprises a nitrogen-containing compound, and
on at least one surface of the flame-retardant insulating sheet, a peak density (Spd) is 8,000 (1/mm²) or more.

3. A flame-retardant insulating sheet, comprising:
a polycarbonate resin; and
a flame retardant,
wherein the flame retardant comprises a nitrogen-containing compound, and
on at least one surface of the flame-retardant insulating sheet, a 60° glossiness is 25 or less.

4. The flame-retardant insulating sheet according to claim 1, wherein a 60° glossiness on the surface is 25 or less.

5. The flame-retardant insulating sheet according to claim 1, further comprising:
a coloring material.

6. The flame-retardant insulating sheet according to claim 5,
wherein the coloring material is carbon black.

7. The flame-retardant insulating sheet according to claim 1,
wherein a weight-average molecular weight of the polycarbonate resin is 15,000 to 35,000.

8. The flame-retardant insulating sheet according to claim 1,
wherein the flame retardant is melamine cyanurate.

9. The flame-retardant insulating sheet according to claim 1,
wherein an average particle diameter of the flame retardant is 1 to 30 μm.

10. The flame-retardant insulating sheet according to claim 1,
wherein, in the flame-retardant insulating sheet, a proportion of a content of the flame retardant to a content of the polycarbonate resin is 2% to 10% by mass.

11. An electrical/electronic device using the flame-retardant insulating sheet according to claim 1.
